(19) United States
(12) Patent Application Publication
(10) Pub. No.: US 2013/0328840 A1
(43) Pub. Date: Dec. 12, 2013

(54) DISPLAY PANEL, DISPLAY DEVICE PROVIDED WITH DISPLAY PANEL, AND ELECTRONIC DEVICE PROVIDED WITH DISPLAY PANEL

(71) Applicant: Yohsuke Fujikawa, Osaka (JP)

(72) Inventor: Yohsuke Fujikawa, Osaka (JP)

(73) Assignee: SHARP KABUSHIKI KAISHA, Osaka (JP)

(21) Appl. No.: 14/000,964

(22) PCT Filed: Feb. 20, 2012
(86) PCT No.: PCT/JP2012/054003

§ 371 Date: Aug. 22, 2013

(30) Foreign Application Priority Data
Feb. 25, 2011 (JP) 2011/040636

(51) Int. Cl. G09G 5/00

(52) U.S. Cl. CPC G09G 5/003
USPC 345/204

(57) ABSTRACT

In a display panel (1) according to the present invention, where the pitch at which a plurality of first row control wires (11A) are arranged in a first display screen (10A) is set to P_PIX1, and the pitch at which a plurality of unit circuits (13a) are arranged in a first row control circuit (13A) is set to P_D1, the relationship P_PIX1>P_D1 is established. Furthermore, from among the plurality of first row control lines (11A) drawn between the first row control circuit (13A) and the first display screen (10A), lines closer to external terminals (9) have longer diagonal lines, and lines closer to a second display screen (10B) have shorter diagonal lines.

### TECHNICAL FIELD

The present invention relates to a display panel in which various driver circuits are monolithically formed on a substrate, to a display device including this display panel, and to an electronic device including this display panel.

### BACKGROUND ART

Display panels, represented by liquid crystal panels, are in general use and installed in various electronic devices, and in particular, mobile electronic devices. In recent years, in order to accomplish further miniaturization, display panels in which various driver circuits using polycrystalline silicon are formed monolithically on a substrate have been made into products. In addition, display panels having two display screens on one display panel have been made into products, relying on the fact that various circuits can be formed on one substrate.

A display panel including two display screens is disclosed in Patent Document 1, for example. The configuration of such a display panel will be described with reference to FIGS. 4 and 5. FIGS. 4 and 5 are perspective views showing schematic configurations of a display panel.

As shown in FIG. 4, a display panel 100 has a configuration in which an opposite substrate 103 and an element substrate 105 made of glass are bonded together. When viewing this display panel 100 in a plan view (in other words, when viewing the display panel 100 from above), external terminals 109, a first display screen 110A, and a second display screen 110B are aligned in this order on the display panel 100. In this case, the external terminals 109 are provided in a portion of a frame region opposite to the second display screen 110B across the first display screen 110A, the frame region (edge part) surrounding the first display screen 110A and the second display screen 110B. Thus, the external terminals 109 are provided only on one out of the four sides constituting the frame region. This configuration in which the external terminals 109 are disposed on only one side of the frame region is referred to as a “three sides-free structure,” and in recent years is a preferred configuration due to the advantage that installation into electric devices is easier.

In the display panel 100, the first display screen 110A conducts transmissive color display at a high resolution (640RGB×960, for example), and the second display screen 110B conducts transflective black and white display at a low resolution (208×40, for example). The display panel 100 includes the first display screen 110A and the second display screen 110B, and thus, it is possible to differentiate display depending on what is to be displayed and different uses.

As shown in FIG. 5, the first display screen 110A includes two first row control circuits 113A and a first column control circuit 114A that control the first display screen 110A, and a first opposite electrode 102A. The second display screen 110B includes a second row control circuit 113B and a second column control circuit 114B that control the second display screen 110B, and a second opposite electrode 102B. The first display screen 110A and the second display screen 110B are electrically independent of each other, and if necessary, it is possible to stop the operation of one of the display screens, thereby cutting down on power consumption.

In the first display screen 110A, individual display elements are formed in the vicinity of the intersection points between a plurality of first row control lines 111A and a plurality of first column control lines 112A, and each display element has a thin film transistor (not shown in drawings) and a pixel electrode (not shown in drawings) as basic components. Similarly, in the second display screen 110B, individual display elements are formed in the vicinity of the intersection points of a plurality of second row control lines 111B and a plurality of second column control lines 112B, and each display element has a thin film transistor (not shown in drawings) and a pixel electrode (not shown in drawings) as basic components. The two first row control circuits 113A are respectively disposed in two frame regions parallel to the plurality of first column control lines 112A (in other words, the left and right edges) of the frame region surrounding the first display screen 110A, and control the plurality of first row control lines 111A (gate bus lines) from the left and right. The first row control circuits 113A sometimes include circuits 107 such as buffer circuits or protective circuits on the ends thereof on the side of the external terminals 109. The first column control circuit 114A is disposed in the frame region between the external terminals 109 and the first display screen 110A, and controls the plurality of first column control lines 112A (source bus lines). The first column control circuit 114A may be provided with protective circuits 6 on both ends thereof on the side of the first row control circuits 113A.

The first column control circuit 114A fulfills the role of a simple RGB switch that sorts video signals from driver ICs 116 to first column control lines 112A of respective subpixels of red (R), green (G), and blue (B), which constitute one pixel. As a result, it is possible to reduce the number of output wiring lines from the driver IC 116, allowing high resolution display even with a small number of driver ICs 116.

The first opposite electrode 102A is electrically connected to the external terminals 109 of the element substrate 105 through first common transfer wiring lines 115A and common transfer parts 120A to 120D. In FIG. 5, there are four common transfer parts (A to D) connected to the first common transfer wiring lines 115A, and the common transfer parts are formed in the vicinity of the four corners of the first display screen 110A. The second opposite electrode 102B is electrically connected to the external terminals 109 on the element substrate 105 through second common transfer wiring lines 115B and common transfer parts 120E to 120H. In FIG. 5, there are four common transfer parts (E to H) connected to the second common transfer wiring lines 115B, and the common transfer parts are formed in the vicinity of the four corners of the second display screen 110B.

The respective common transfer parts 120A to 120D and the opposite electrode 102A, and the respective common transfer parts 120E to 120H and the opposite electrode 102B, are respectively connected electrically through a conductive member or a conductive paste included in a sealing member 104. Control lines necessary to drive the second display screen 110B (including power lines and clock signal lines) pass through the frame region of the display panel 100 so as to avoid the first row control circuits 113A of the display panel 100, and are drawn to the external terminals 109 provided in the display panel 100.

### RELATED ART DOCUMENT

### Patent Document

Patent Document 1: Japanese Patent Application Laid-Open Publication, “Japanese Patent Application Laid-Open Publication No. 2001-75503 (Published on Mar. 23, 2001)”

### SUMMARY OF THE INVENTION

### Problems to be Solved by the Invention

In the display panel 100 shown in FIG. 5, the external terminals 109, the first display screen 110A, and the second display screen 110B are aligned in this order, and thus, the control lines of the second display screen 110B are drawn to the external terminals 109 passing the sides of the first row control circuits 113A while avoiding them. As a result, wiring lines are concentrated in the corners of the frame region on the side of the external terminals 109 in the display panel 100. As a result, the frame region on the side of the external terminals 109 of the display panel 100 becomes large, which means that advantages of an electronic device, including the display panel 100, as a product are diminished.

The present invention takes into account the above-mentioned problem, and an object thereof is to provide a display panel in which it is possible to prevent the corner portions of the frame region on the side of the external terminals in the display panel from becoming large due to the concentration of wiring lines in the corner portions of the frame region on the side of the external terminals of the display panel, a display device provided with the display panel, and an electronic device provided with the display panel.

### Means for Solving the Problems

In order to solve the above-mentioned problems, a display panel according to an embodiment of the present invention includes: a substrate having a display region and a frame region that is a non-display region surrounding the display region; external terminals disposed on only one side out of four sides constituting the frame region; a first display screen provided in the display region, the first display screen including a plurality of first row control lines disposed so as to be parallel to a side where the external terminals are disposed, and a plurality of first column control lines intersecting with the plurality of first row control lines; a second display screen provided in a position of the display region opposite to the external terminals across the first display screen, the second display screen including a plurality of second row control lines that are fewer in number than the plurality of first row control lines and that are disposed so as to be parallel to the plurality of first row control lines, and a plurality of second column control lines that intersect with the plurality of second row control lines; a first row control circuit disposed on the side perpendicular to the side where the external terminals are disposed, the first row control circuit including a plurality of first row unit circuits, respectively provided for the respective first row control lines and arranged along a direction perpendicular to the plurality of first row control lines; a second row control circuit disposed on the side where the first row control circuit is disposed, the second row control circuit including a plurality of second row unit circuits, respectively provided for the respective second row control lines and arranged along a direction perpendicular to the plurality of second row control lines; and control lines for controlling the second display screen that extend through the frame region from the external terminals to the second display screen so as to avoid the first row control circuit, wherein a pitch at which the plurality of first row unit circuits are arranged is less than a pitch at which the plurality of first row control lines are arranged, and wherein an edge of the first display screen on a side of the second display screen, and an edge of the first row control circuit on a side of the second row control circuit are aligned in substantially one line with respect to each other.

According to the configuration above, it is possible to shorten the length (column direction dimension) of the first row control circuit. As a result, an open region can be formed in the frame region in the periphery of the first display screen.

In addition, the edge of the first row control circuit on a side of the second row control circuit is aligned on substantially one line with the edge of the first display screen on a side of the second display screen. As a result, the edge of the first row control circuit on the side of the external terminals can be moved towards the second row control circuit. As a result, an opening is formed in the frame region on the external terminal side, or more specifically, the corners of the frame region on the external terminal side.

As a result, along with making the pitch at which the plurality of first row unit circuits are arranged smaller than that of the plurality of first row control lines, the edge of the first row control circuit on the side of the second row control circuit is aligned on substantially one line with the edge of the first display screen on the side of the second display screen, and thus, it is possible to have an open region in the corners of the display panel. In this open region, control lines (including power lines and clock signal lines) can be drawn to the external terminals. In other words, it is possible to draw the control lines of the second display screen to the external terminals without increasing the size of the frame region on the side of the external terminals due to the concentration of wiring lines at the corners of the frame region on the side of the external terminals.

Also, the display device according to one aspect of the present invention includes the above-mentioned display panel.

According to this configuration, it is possible to draw the control lines for controlling the second display screen to the external terminals without increasing the size of the frame region on the side of the external terminals due to the concentration of wiring lines at the corners of the frame region on the side of the external terminals. As a result, a display panel with a high merchantability can be provided.

Also, an electronic device according to one aspect of the present invention includes the above-mentioned display panel.

According to this configuration, it is possible to draw the control lines for controlling the second display screen to the external terminals without increasing the size of the frame region on the side of the external terminals due to the concentration of wiring lines at the corners of the frame region on the side of the external terminals. As a result, an electronic device with a high merchantability can be provided.

Additional objects, features, and effects of the present invention shall be readily understood from the descriptions that follow. Advantages of the present invention shall become apparent by the following descriptions with reference to the appended drawings.

### Effects of the Invention

According to the present invention, it is possible to draw the control lines for controlling the second display screen to the external terminals without increasing the size of the frame region on the side of the external terminals due to the concentration of wiring lines at the corners of the frame region on the side of the external terminals. As a result, it is possible to increase the merchantability of the display device or the electronic device using the display panel. Also, by reducing the size of the frame region, it is possible to have a plurality of display panels on the substrate, and as a result, it is possible to mitigate an increase in manufacturing cost of the display panel.

### BRIEF DESCRIPTION OF THE DRAWINGS

FIG. 1 is a magnified view of a portion of an element substrate in a display panel according to one embodiment of the present invention.

FIG. 2 is a perspective view showing a schematic configuration of the display panel according to the one embodiment of the present invention.

FIG. 3 shows a qualitative relationship between the pitch at which a plurality of unit circuits of a first row control circuit are arranged, and the width of each unit circuit.

FIG. 4 is a perspective view showing a schematic configuration of a conventional display panel.

FIG. 5 is a perspective view showing a schematic configuration of a conventional display panel.

### DETAILED DESCRIPTION OF EMBODIMENTS

An embodiment of the present invention will be described below with reference to drawings.

(1. Configuration of Display Panel)

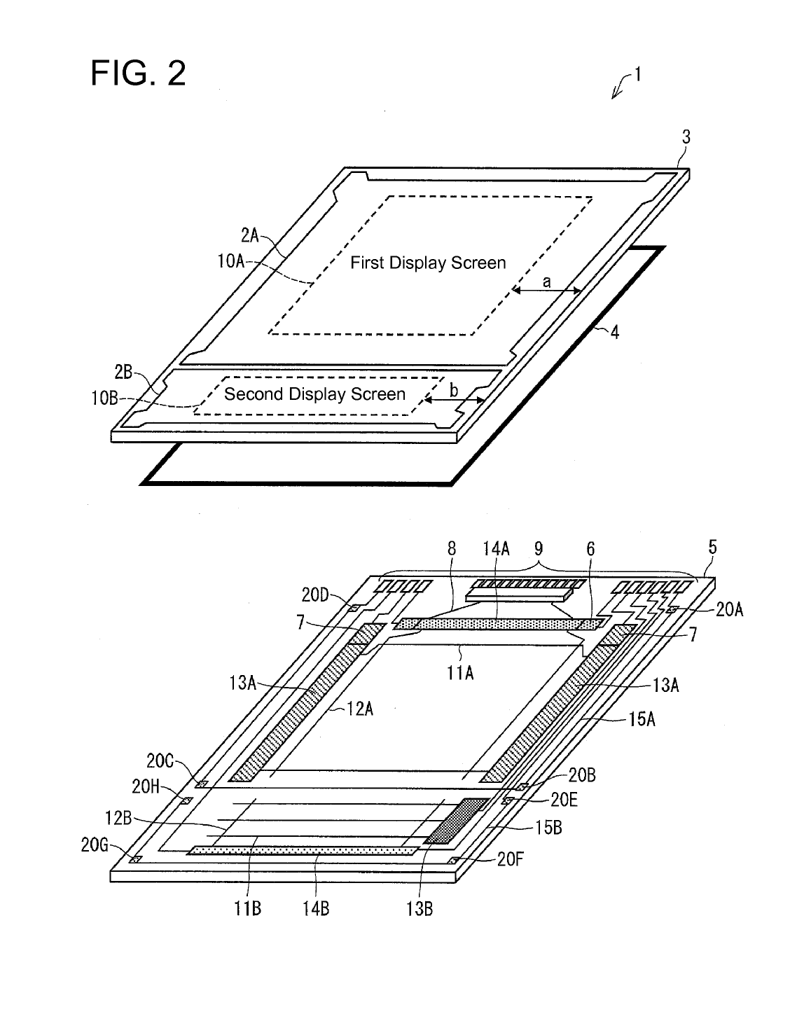

First, a configuration of a display panel of the present embodiment will be explained with reference to FIG. 2. FIG. 2 is a perspective view that shows a schematic configuration of a display panel 1 of the present embodiment. For ease of description, in the description below, the extension direction of first row control lines and second row control lines will be designated as the row direction, and the extension direction of first column control lines and second column control lines will be designated as the column direction. However, with regards to usage of the display panel 1 according to the present embodiment, it is apparent that the first row control line and the second row control line may extend in the horizontal direction or the vertical direction. A case will be described below in which the display panel 1 is a liquid crystal panel, but the present embodiment is not limited thereto.

As shown in FIG. 2, the display panel 1 of the present embodiment has the same configuration as a conventional display panel in which components are respectively formed on surfaces of an opposite substrate 3 and an element substrate 5 made of glass with the substrates bonded to each other through a sealing member 4 such that the components of the respective substrates face each other. In a plan view (in other words, when viewing the display panel 1 from above), the display panel 1 has external terminals 9, a first display screen 10A, and a second display screen 10B of the display panel 1, aligned in this order. In this case, the external terminals 9 are disposed in a portion of a frame region extending in the row direction (in other words, in an edge on the upper side of the page) in the frame region (edge) surrounding the first display screen 10A and the second display screen 10B, so as to be opposite to the second display screen 10B across the first display screen 10A. Thus, the display panel 1 has a so-called “three sides-free structure” in which the external terminals 9 are provided on only one out of the four sides constituting the frame region.

The first display screen 10A includes two first row control circuits 13A and a first column control circuit 14A that control the first display screen 10A, and a first opposite electrode 2A. The first opposite electrode 2A is electrically connected to the external terminals 9 of the element substrate 5 through first common transfer wiring lines 15A and common transfer parts 20A to 20D. In FIG. 2, there are four common transfer parts (A to D) connected to the first common transfer wiring lines 15A, and the common transfer parts are formed in the vicinity of the four corners of the first display screen 10A. A potential to be generated from the opposite electrode 2A is applied to the common transfer parts 20A to 20D through the common transfer wiring lines 15A.

On the other hand, the second display screen 10B includes a second row control circuit 13B and a second column control circuit 14B that control the second display screen 10B, and a second opposite electrode 2B. The second opposite electrode 2B is electrically connected to the external terminals 9 of the element substrate 5 through second common transfer wiring lines 15B and common transfer parts 20E to 20H. In FIG. 2, there are four common transfer parts (E to H) connected to the second common transfer wiring lines 15B, and the common transfer parts are formed in the vicinity of the four corners of the second display screen 10B. A potential to be generated from the opposite electrode 2B is applied to the common transfer parts 20E to 20H through the common transfer wiring lines 15B.

The respective common transfer parts 20A to 20D and the opposite electrode 2A, and the respective common transfer parts 20E to 20H and the opposite electrode 2B are respectively connected electrically through a conductive member included in the sealing member 4. The common transfer parts 20A to 20D and the opposite electrode 2A, and the common transfer parts 20E to 20H and the opposite electrode 2B can respectively be connected through a conductive paste. However, because the first display screen 10A and the second display screen 10B are close to each other, the common transfer parts 20B, 20C, 20E, and 20H are also close to each other, which poses the risk of short-circuiting if errors occur when coating with the conductive paste. Thus, it is preferable that a conductive member be used in order to connect the respective common transfer parts 20A to 20D to the opposite electrode 2A, and to connect the respective common transfer parts 20E to 20H to the opposite electrode 2B.

The first display screen 10A and the second display screen 10B are electrically independent of each other, and if necessary, it is possible to stop the operation of one of the display screens, thereby cutting down on power consumption. In the present embodiment, the first display screen 10A conducts transmissive color display at a high resolution (4.23 inch display at 540RGB×960, for example), and the second display screen 10B conducts transflective black and white display at a low resolution (2.07 inch display at 304×56, for example). In other words, where the number of rows in the first display screen (number of first row control lines 11A) is “m,” and the number of rows in the second display screen (number of second row control lines 11B) is “n,” a relation of m>n is established. Therefore, the number of second row control lines 11B is less than the number of first row control lines 11A.

(2. Configuration of Display Screens)

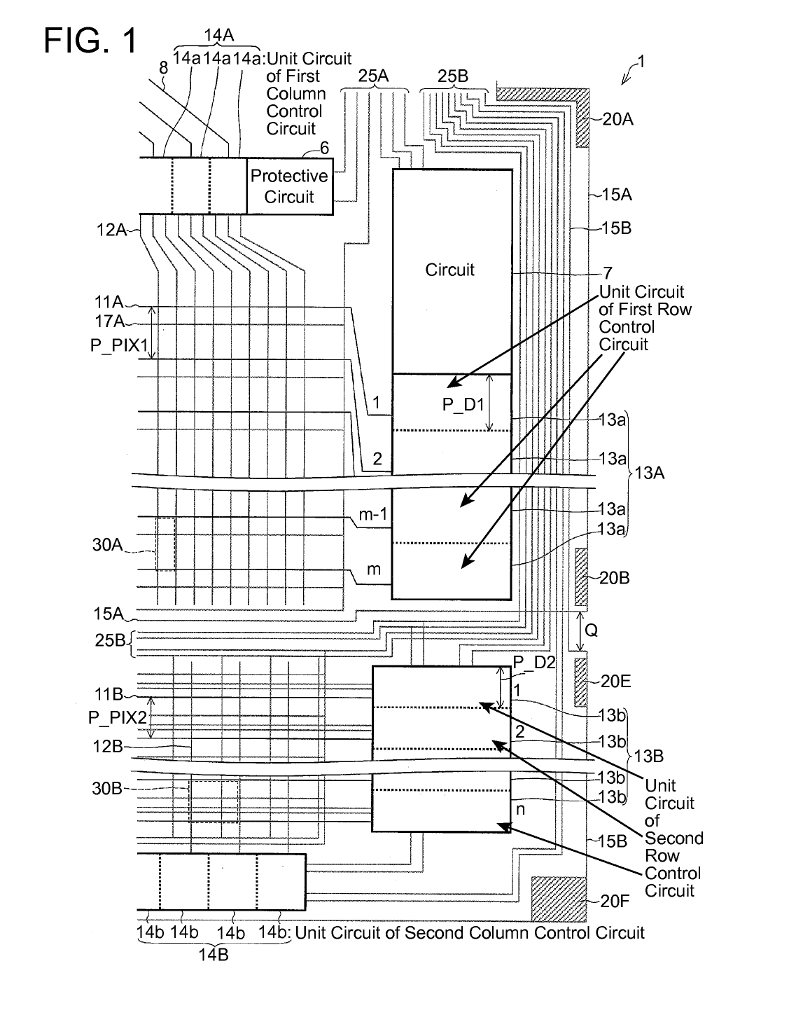

The configuration of the display screens of the display panel 1 will be described with reference to FIG. 1. FIG. 1 is a magnified view of a portion of the element substrate 5 of the display panel 1 according to the present embodiment.

As shown in FIG. 1, driver circuits such as the two first row control circuits 13A, the second row control circuit 13B, the first column control circuit 14A, and the second column control circuit 14B, and the external terminals 9 are formed monolithically on the element substrate 5 of the display panel 1. The driver circuits and the external terminals 9 are disposed in the frame region in the periphery of the display region (first display screen 10A and second display screen 10B) in the display panel 1. The frame region is a non-display region where images are not displayed.

In the element substrate 5 of the display panel 1, the first display screen 10A includes the plurality of first row control lines 11A, the plurality of first column control lines 12A, and a plurality of first storage capacitance lines 17A. The plurality of first row control lines 11A (gate bus lines) extend in the row direction (horizontal direction on the page), and the plurality of first column control lines 12A (source bus lines) extend in the column direction (vertical direction on the page). The plurality of first row control lines 11A and the plurality of first column control lines 12A intersect each other to form a matrix, and each region surrounded by one first row control line 11A and one first column control line 12A is a subpixel. In other words, in FIG. 1, the region surrounded by the dotted line of the reference character 30A is one subpixel area. The first display screen 10A has subpixels constituting each pixel arranged in a matrix.

The two first row control circuits 13A are respectively disposed in two frame regions extending in the row direction (in other words, edges on the left and right of the page) of the frame region in the periphery of the first display screen 10A, and control the plurality of first row control lines 11A from the left and right. Therefore, of the four sides constituting the frame region, the first row control circuits 13A are disposed on the two sides perpendicular to the side where the external terminals 9 are disposed. On the other hand, the first column control circuit 14A is disposed at the frame region between the external terminals 9 and the first display screen 10A (in other words, the upper edge on the page). Therefore, of the four sides constituting the frame region, the first column control circuit 14A is disposed on the side where the external terminals 9 are disposed. The first column control circuit 14A controls the plurality of first column control lines 12A. The plurality of first storage capacitance lines 17A are for generating auxiliary capacitance and extend in the row direction, and are disposed between two adjacent first row control lines 11A.

On the other hand, the second display screen 10B includes the plurality of second row control lines 11B extending in the row direction (horizontal direction on the page), and the plurality of second column control lines 12B extending in the column direction (vertical direction on the page). The plurality of second row control lines 11B and the plurality of second column control lines 12B intersect each other to form a matrix, and a region surrounded by one second row control line 11B and one second column control line 12B is one pixel. In other words, in FIG. 1, the region surrounded by the dotted line of the reference character 30B is one pixel area. The second display screen 10B has a configuration in which the above-mentioned pixels are arranged in a matrix.

The second row control circuit 13B is disposed on either one of two frame regions extending in the column direction (in other words, edges on the left and right of the page) of the frame region in the periphery of the second display screen 10B, and controls the plurality of second row control lines 11B. Therefore, of the four sides constituting the frame region, the second row control circuit 13B is disposed on either of the two sides where the two first row control circuits 13A are disposed. On the other hand, the second column control circuit 14B is disposed in the frame region opposite to the first display screen 10A across the second display screen 10B and extending in the row direction (in other words, the lower edge on the page) of the frame region in the periphery of the second display screen 10B. Therefore, of the four sides constituting the frame region, the second column control circuit 14B is disposed on the side opposite to the side where the external terminals 9 are disposed. The second column control circuit 14B controls the plurality of second column control lines 12B.

The individual display elements in the first display screen 10A are respectively formed in the vicinity of the intersection points between the plurality of first row control lines 11A and the plurality of first column control lines 12A, and each display element has a thin film transistor (not shown in drawings), a pixel electrode (not shown in drawings), and a first storage capacitance line 17A as basic components. In other words, the display element is disposed for each subpixel.

In each subpixel, a color filter (not shown in drawings) having a color of red (R), green (G), or blue (B) is disposed for each pixel electrode. Subpixels having red color filters, subpixels having green color filters, and subpixels having blue color filters are respectively referred to below as red (R) subpixels, green (G) subpixels, and blue (B) subpixels. In the first display screen 10A, three RGB subpixels are disposed in the row direction or the column direction. A group of subpixels constituted of three RGB subpixels is a pixel (pixel for displaying three primary colors), which is the minimum unit for conducting color display. In other words, one pixel is constituted of three RGB subpixels.

Where the column direction pitch (in other words, the pitch at which the plurality of first row control lines 11A are arranged) of the subpixels, which are constituent units of the first display screen 10A, is P_PIX1, the row direction pitch (in other words, the pitch at which the plurality of first column control lines 12A are arranged) is ⅓ of P_PIX1. This is because three RGB subpixels constitute one pixel.

On the other hand, in the second display screen 10B, individual display elements are formed in the vicinity of the respective intersection points of the plurality of second row control lines 11B and the plurality of second column control lines 12B, and the display elements each have a thin film transistor (not shown in drawings) and a pixel electrode (not shown in drawings) as basic components. In other words, the display element is disposed for each pixel.

Where the column direction pitch (in other words, the pitch at which the plurality of second row control lines 11B are arranged) of the pixels, which are the constituent units of the second display screen 10B, is P_PIX2, the row direction pitch (in other words, the pitch at which the plurality of second row control lines 12B are arranged) is equal to P_PIX2. This is because square pixels are used due to the fact that the second display screen 10B conducts black and white display. However, the configuration is not limited thereto, and the horizontal/vertical aspect ratio of each pixel may be a ratio other than 1:1. Thus, the constituent unit pixels of the second display screen 10B may be subpixels as in the first display screen 10A, instead of having the aspect ratio of the pixel of the second display screen 10B be 1:1, for example.

(3. Driving of Display Elements) As stated above, in the present embodiment, the display elements of the first display screen 10A are respectively formed in the vicinity of the intersection points of the plurality of first row control lines 11A and the plurality of first column control lines 12A. Each display element has a thin film transistor (not shown in drawings), a pixel electrode (not shown in drawings), and a storage capacitance line 17A as basic components, and the display elements are configured to conduct dot inversion driving in which the first opposite electrode 2A applies DC. On the other hand, the second display screen 10B has a configuration in which it is possible to conduct driving using the so-called “pixel memory LCD” in which each pixel is provided with a pixel memory that stores image data supplied from an IC driver. The respective display elements in the second display screen 10B are formed in the vicinity of the intersection points between the plurality of second row control lines 11B and the second column control lines 12B. Each display element has SRAM (not shown in drawings), and is configured such that the second opposite electrode 2B conducts frame inversion driving, which involves AC driving. Thus, the respective display elements of the second display screen 10B have, besides the second row control lines 11B and the second column control lines 12B, a power line for driving the SRAM, a power line for applying binary voltage to the liquid crystal, and a plurality of thin film transistors (not shown in drawings). The circuits for driving the second display screen 10B (such as the timing generator and the VCOM circuit) may be installed monolithically into the element substrate 5.

(4. Configuration of First Row Control Circuits and First Row Control Lines)

In the first display screen 10A, in the element substrate 5, the two first row control circuits 13A are respectively disposed monolithically in the two frame regions extending in the column direction (in other words, the edges in the left and right direction of the page) of the frame region in the periphery of the first display screen 10A. These first row control circuits 13A drive an “m” number (960 if the resolution is 540RGB×960, for example) of first row control lines 11A respectively from the left and right. This configuration is suited to driving a high resolution display and contributes to a decrease in crosstalk (also referred to as shadowing).

From the first row control circuits 13A, control lines 25A (including power source lines and clock signal lines) are drawn to the external terminals 9, passing through the frame region in the vicinity of the external terminals 9. In the display panel 1 shown in FIG. 1, circuits 7 such as buffer circuits or protective circuits are provided on the edges of the first row control circuits 13A on the side of the external terminals 109. These circuits 7 simply need to be provided as needed and do not necessarily need to be provided.

The first row control circuits 13A are constituted of multiple unit circuits 13a (first row unit circuits) disposed at a prescribed pitch in the column direction, each of which includes a shift register and an output circuit. Each unit circuit 13a may be provided with a level shifter as necessary. In the present embodiment, where the pitch at which the plurality of first row control lines 11A are arranged is P_PIX1 and the pitch at which the plurality of unit circuits 13a of the first row control circuits 13A are arranged is P_D1, the plurality of first row control lines 11A and the plurality of unit circuits 13a are disposed such that P_PIX1>P_D1.

By reducing the pitch at which the plurality of unit circuits 13a are arranged, the length of the first row control circuit 13A (column direction (vertical direction on the page) dimension) can be shortened. As a result, an open region can be formed in the frame region in the periphery of the first display screen 10A. Specifically, if the resolution is 540RGB×960 then “m”=960, and with a reduction 0.5 μm each, an open region of 480 μm can be formed.

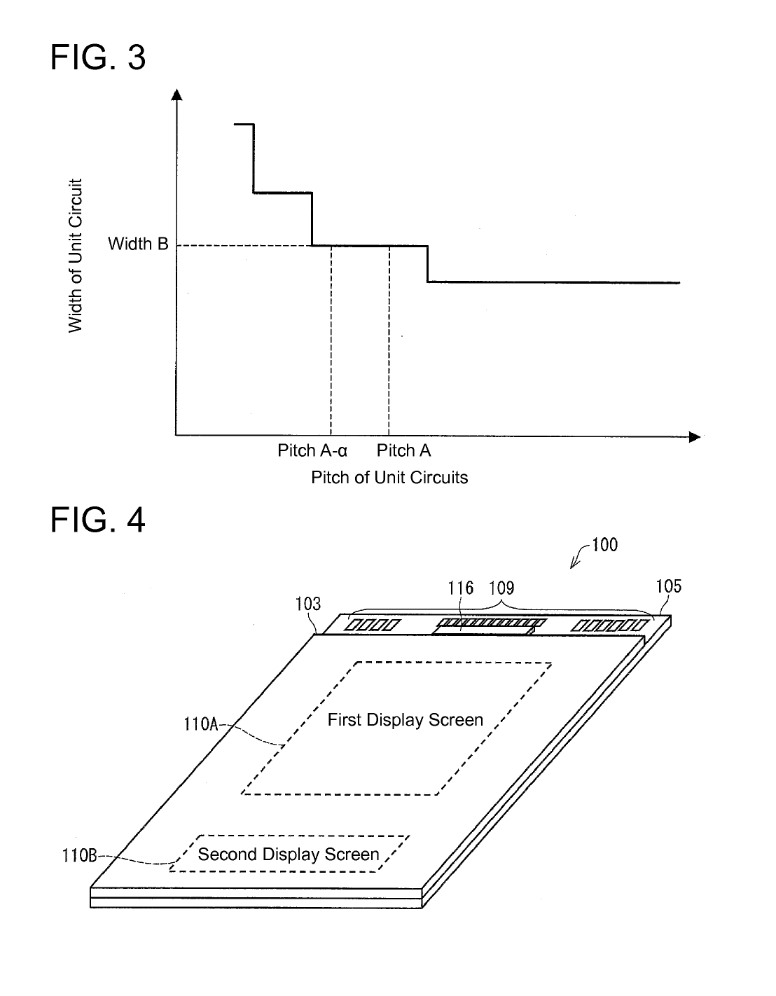

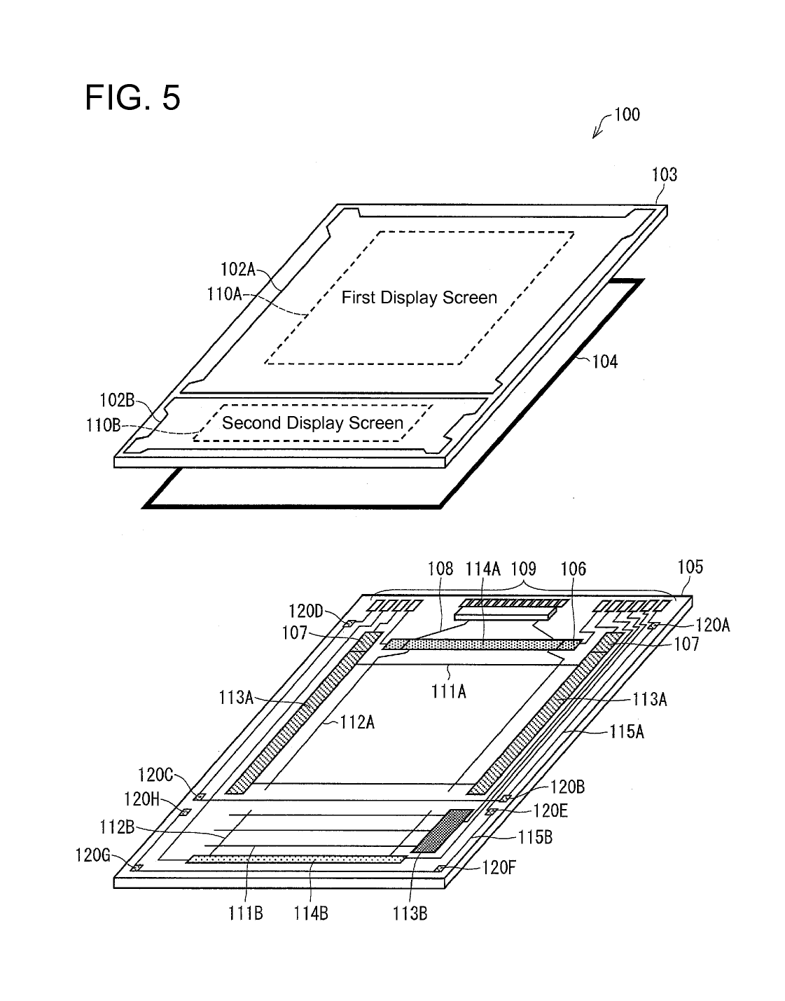

The pitch (P_D1) at which the plurality of unit circuits 13a are arranged is reduced such that the difference between P_PIX1 and P_D1 is a small value of approximately 0.5 μm, for example. Such a reduction in the pitch at which the plurality of unit circuits 13a are arranged can be attained with relative ease and without increasing the width of the first row control circuits 13A (row direction (horizontal direction on the page) dimension) if redundant gaps between each of the plurality of unit circuits 13a are used. Reasons that the above-mentioned reduction in pitch is possible will be described below with reference to FIG. 3. FIG. 3 shows a qualitative relationship between the pitch at which the plurality of unit circuits 13a are arranged and the width of each of the unit circuits 13a.

In general, it is rare for unit circuits to be arranged at a certain L/S (line/space) permitted by design, and unit circuits often include a small open space resulting from circumstances of how the various components are disposed such as the direction that the thin film transistors face or the direction that the wiring lines face. As a result of the pitch P_PIX1 at which the plurality of first row control lines are arranged being at a pitch A, and the plurality of unit circuits also being disposed at the pitch A, the unit circuits have a width B, for example. In such a case, as shown in FIG. 3, even if the pitch at which the plurality of unit circuits are arranged is modified to A-α, it is possible to maintain the width of the unit circuits at B. As shown in FIG. 3, the pitch at which the plurality of unit circuits are arranged and the width of each unit circuit have a discrete relationship.

Thus, if the pitch at which the plurality of unit circuits 13a are arranged is reduced too much, as shown in FIG. 3, the width of each unit circuit 13a becomes large. Thus, in the present embodiment, it is preferable that the width of each unit circuit 13a be equal to the width of each unit circuit 13a when the plurality of first row control lines 11A and the plurality of unit circuits 13a have the same pitch, and that the pitch at which the plurality of unit circuits 13a are arranged be less than the pitch at which the plurality of first row control lines 11A are arranged. According to this, even if the pitch at which the plurality of unit circuits 13a are arranged is reduced, due to potential characteristics of the unit circuits 13a, the width of the unit circuits 13a does not change, which means that the frame region does not become narrow where the first row control circuits 13A are provided. In other words, even if the pitch at which the plurality of unit circuits 13a are arranged were reduced, there is no need to increase the outer dimensions of the display panel 1 in order to increase the width of the frame region (row direction (horizontal direction on the page) dimension) where the first row control circuits 13A are provided.

Thus, as a result of the width of the unit circuits 13a not becoming unreasonably large, where the dimensions of the frame region on the left and right of the first display screen 10A (in other words, the minimum distance from the edge of the first display screen 10A perpendicular to the side where the external terminals 9 are disposed, to the edge of the substrate 3 parallel to the edge) are “a,” and the dimensions of the frame region on the left and right of the second display screen 10B (minimum distance from the edge of the second display screen 10B perpendicular to the side where the external terminals 9 are disposed, to the edge of the substrate 3 parallel to the edge) are “b,” a display panel 1 is obtained in which “a” is substantially equal to “b” (a≈b). Thus, the display panel 1 can be suitably installed in an electronic device.

Here, a≈b means that depending on the combination of the pixel configuration of the first display screen 10A (pitch, number) and the pixel configuration of the second display screen 10B (pitch, number), “a” is not necessarily simply equal “b” in a geometric manner. Thus, as long as the difference therebetween does not impede the convenience for the user, “a” may be greater than “b” or “a” may be less than “b,” as appropriate.

If the width of the unit circuits 13a becomes large, “a” can be deliberately made greater than “b.” In such a case, it is possible to increase the diagonal size of the second display screen 10B without changing the horizontal width of the display panel 1 (horizontal direction dimension on the page). Thus, this configuration is suitable when the diagonal size of the second display screen 10B is to be emphasized. Also, it is preferable to have an optimal diagonal size when taking into consideration installation into an electronic device and the accuracy of installation into an electronic device.

In addition, in the present embodiment, of the plurality of first row control lines 11A drawn between the first row control circuit 13A and the first display screen 10A, the first row control lines 11A disposed closer to the external terminals 9 have longer diagonal portions. On the other hand, the first row control lines 11A disposed closer to the second display screen 10B have shorter diagonal portions. In other words, the closer the first row control lines 11A are to the second display screen 10B, the more horizontal they are (parallel to the first row control lines 11A).

In other words, the pitch at which the plurality of unit circuits 13a are arranged is reduced, and the edge of the first row control circuits 13A on the side of the second row control circuit 13B, and the edge of the first display screen 10A on the side of the second display screen 10B are made to be substantially on the same line. As a result, the edge of the first row control circuits 13A on the side of the external terminals 9 can be moved towards the side of the second row control circuit 13B. As a result, it is possible to also move the circuits 7 such as buffer circuits or protective circuits towards the second display screen 10B, and thus, an open region is formed in the frame region on the side of the external terminals 9, or more specifically the corners of the frame region on the side of the external terminals 9.

Thus, according to the present embodiment, by reducing the pitch at which the plurality of unit circuits 13a are arranged to less than that of the plurality of first row control lines 11A and having the edge of the first row control circuits 13A on the side of the second row control circuits 13B be on substantially the same line as the edge of the first display screen 10A on the side of the second display screen 10B, it is possible to have an open region in the corners of the display panel 10. In this open region, control lines 25B (including power lines and clock signal lines) necessary to drive the second display screen 10B can be drawn to the external terminals 9. In other words, it is possible to draw the control lines 25B of the second display screen to the external terminals 9 without increasing the size of the frame region on the side of the external terminals 9 due to the concentration of wiring lines at the corners of the frame region on the side of the external terminals 9.

In this manner, it is possible to reduce the outer size of the display panel 1, and thus, it is possible to have a better product as a display device or an electronic device using the display panel 1. Also, by reducing the size of the frame region, it is possible to have a plurality of display panels 1 on the substrate, and as a result, it is possible to mitigate an increase in manufacturing cost of the display panel 1.

(5. Configuration of First Column Control Circuit and First Column Control Lines)

The first column control circuit 14A of the first display screen 10A is disposed monolithically in the frame region between the external terminals 9 and the first display screen 10A (in other words, the upper edge thereof on the page) on the element substrate 5. The first column control circuit 14A drives the respective plurality (if the resolution is 540RGB×960, then a resolution of 540×3, for example) of first column control lines 12A.

The first column control circuit 14A is connected to a driver IC installed externally on the display panel 1 through video signal lines 8. Here, the first column control circuit 14A has multiple unit circuits 14a (first column unit circuits) having switch circuits and extending in the row direction, the unit circuits 14a being disposed at a prescribed pitch. Each unit circuit 14a may be provided with a level shifter as necessary. The video signal from the driver IC is sent to each unit circuit 14a of the first column control circuit 14A through the video signal lines 8. The first column control circuit 14A has the role of a simple RGB switch that allocates input from one video signal line 8 to the first column control lines 12A (three first column control lines 12A) for the respective subpixels of red (R), green (G), and blue (B), which constitute one pixel. As a result, it is possible to have fewer video signal lines 8 (540 if the resolution is 540RGB×960, for example) than the first column control lines 12A necessary to drive the first display screen 10A (540×3 if the resolution is 540RGB×960, for example). In other words, it is possible to reduce the number of output wiring lines from the driver IC, which makes it possible to have high resolution display even with a small number of driver ICs. Also, by reducing the number of output wiring lines from the driver IC, it is possible to improve the reliability and decrease number of parts in the display panel 1.

From the first column control circuit 14A, control lines 25A (including power lines and clock signal lines) are drawn to the external terminals 9, passing through the frame region in the vicinity of the external terminals 9. Protective circuits 6 for protecting the control lines 25A drawn from the first column control circuit 14A from static electricity may be respectively disposed on both edges of the first column control circuit 14A towards the first row control circuits 13A. The protective circuits 6 jutting out in the row direction from the first column control circuit 14A have a possibility of interfering with the first row control circuits 13A, and thus, in some cases, the outer dimensions of the display panel 1 are made bigger in order to avoid such a situation. When providing protective circuits 6, in order to avoid an increase in the outer dimensions of the display panel 1, it is preferable that the pitch at which the plurality of unit circuits 14a are arranged be made slightly smaller than the pitch at which the plurality of first column control lines 12A are arranged. In such a case, the plurality of first column control lines 12A drawn between the first column control circuit 14A and the first display screen 10A are diagonal wiring lines that fan out.

(6. Configuration of Second Row Control Circuit and Second Row Control Lines)

In the second display screen 10B, the second row control circuit 13B is disposed monolithically on the element substrate 5 on either one of two frame regions (in other words, left and right edges on the page) extending in the column direction, of the frame region in the periphery of the second display screen 10B. The second row control circuit 13B drives the respective “n” number (56 if the resolution is 304×56, for example) of second row control lines 11B. In this configuration, the second display screen 10B is low resolution and is driven using black and white pixel memory liquid crystal, and thus, crosstalk is not an issue.

The control lines 25B (including power lines and clock signal lines) are drawn from the second row control circuit 13B to the external terminals 9 so as to avoid the first row control circuit 13A. The second row control circuits 13B are constituted of multiple unit circuits 13b (second row unit circuits) disposed at a prescribed pitch in the column direction, each of which includes a shift register and an output circuit. Each unit circuit 13b may be provided with a level shifter as necessary.

In the present embodiment, where the pitch at which the plurality of second row control lines 11B are arranged in the second display screen 10B is P_PIX2 and the pitch at which the plurality of unit circuits 13b of the second row control circuit 13B are arranged is P_D2, the plurality of second row control lines 11B and the plurality of unit circuits 13b are disposed such that P_PIX2=P_D2. In this case, similar to the first display screen 10A, by making the pitch at which the plurality of unit circuits 13b are arranged smaller than the pitch at which the plurality of second row control lines 11B are arranged, it is possible to have an open region in the frame region. However, because there are a small number of rows in the second display screen 10B (number of second row control lines 11B), even if the pitch at which the plurality of unit circuits 13b are arranged were to be slightly reduced, it is not possible to have a sufficient open space to reduce the area taken up by the whole second row control circuit 13B. For example, if the resolution is 304×56, then “n”=56, and even if the pitch were reduced by approximately 0.5 μm, only 28 μm of open space would result, and even if this reduction were increased by one order of magnitude to 5 μm, only 280 μm of open space would result. Thus, in the second display screen 10B, it is preferable that the pitch at which the plurality of unit circuits 13b are arranged be equal to the pitch at which the plurality of second row control lines 11B are arranged.

(7. Configuration of Second Column Control Circuit and Second Column Control Lines)

The second column control circuit 14B of the second display screen 10B is monolithically disposed in the element substrate 5 in the frame region extending in the row direction and opposite to the first display screen 10A across the second display screen 10B (in other words, the lower frame region on the page) of the frame region in the periphery of the second display screen 10B. The second column control circuit 14B controls the respective plurality (304 if the resolution is 304×56, for example) of second column control lines 12B.

The control lines 25B (including power lines and clock signal lines) are drawn from the second column control circuit 14B to the external terminals 9 through the boundary region between the first display screen 10A and the second display screen 10B so as to avoid the first row control circuit 13A. Here, the control line 25B includes power lines for driving the SRAM provided for each display element in the second display screen 10B and power lines for applying a binary voltage to the liquid crystal, and these power lines go across the second display screen 10B horizontally and vertically.

Here, the second column control circuit 14B has the role of a binary driver for sending a binary signal (turning the display on or off) to each display element of the second display screen 10B. Thus, the voltage for driving the liquid crystal in the second display screen 10B is supplied through the SRAM from the power lines for applying a binary voltage to the liquid crystal.

The second column control circuit 14B is constituted of multiple unit circuits 14b disposed at a prescribed pitch in the row direction, each of which includes a shift register and an output circuit. Each unit circuit 14b may be provided with a level shifter as necessary.

(8. Configuration of Boundary Region Between First Display Screen and Second Display Screen)

The boundary region between the first display screen 10A and the second display screen 10B is a prescribed width Q (approximately 1 mm, for example). Wiring lines for driving the first display screen 10A (first storage capacitance lines 17A and first common transfer wiring lines 15A, for example) can be passed through this boundary region so as to go across the frame region (edges) on the left and right of the page. As a result, it is possible to increase the redundancy of the wiring lines or improve the evenness of the display in the first display screen 10A.

In the boundary region, wiring lines for driving the second display screen 10B may be passed through. By passing power lines necessary to drive the SRAM through the boundary region, for example, it is possible to draw them at a short distance from the outermost portion of the display panel 1 to inside the display panel 1.

In order to have such a configuration, it is necessary to provide an open region of a certain amount between the first row control circuit 13A and the second row control circuit 13B. As stated above, the edge of the first display screen 10A on the side of the second display screen 10B is on substantially the same line as the edge of the first row control circuits 13A on the side of the second row control circuit 13B. Therefore, in the present embodiment, similar to this, the edge of the second display screen 10B on the side of the first display screen 10A is disposed so as to be on substantially the same line as the edge of the second row control circuit 13B on the side of the first row control circuit 13A. As a result, the distance between the first row control circuit 13A and the second row control circuit 13B is substantially equal to the distance Q between the first display screen 10A and the second display screen 10B. As a result, wiring lines for driving the first display screen 10A and wiring lines for driving the second display screen 10B can be reliably passed through the boundary region between the first display screen 10A and the second display screen 10B.

In the configuration above, the display panel 1 has two first row control circuits 13A, but the configuration is not limited thereto. Any configuration may be used as long as a first row control circuit 13A is disposed on at least one of two sides adjacent to the side where the external terminals 9 are disposed, of the four constituent sides of the frame region. The second row control circuit 13B is disposed on the side where the first row control circuit 13A is disposed, of the four constituent sides of the frame region.

Also, in the embodiment of the present invention, a liquid crystal panel using liquid crystal as the display medium was described as an example of a display panel above, but the present invention is not limited thereto. Any display panel may be used as long as the display medium has electro-optical properties, such as electroluminescence (EL), plasma, or electrochromism, for example. The present invention can be applied to display panels of various display devices using various display mediums such as a liquid crystal display device, an EL display device, or an electrophoretic display device. In other words, the present invention can be applied as long as the display panel fulfills a relationship of m>n where “m” is the number of rows in the first display screen and “n” is the number of rows in the second display screen, and as long as the display panel is provided with external terminals on only one of the four constituent sides of the frame region of the display panel.

Thus, the display panel of the present embodiment can be used in an electronic device having the display device as a display part. Such electronic devices include mobile telephones, PDAs (personal digital assistants), DVD (digital versatile disc) players, mobile gaming systems, laptop computers, PC (personal computer) monitors, and television receivers, for example.

The electronic device according to the present embodiment includes the above-mentioned display devices. In other words, the electronic device according to the present embodiment (in other words, an electronic device including the display panel according to the present embodiment) may be a display device such as a liquid crystal display device, or a device that includes such a display device as a display part.

The present invention is not limited to the embodiments described above, and various modifications can be made without departing from the scope of the claims. Therefore, embodiments obtained by appropriately combining the techniques disclosed in different embodiments are included in the technical scope of the present invention.

For example, the display panel of the present invention needs only to include at least the configuration of (4) above, and does not necessarily need the configurations of (5) to (8). Thus, the configurations of (5) to (8) should be seen as configurations that can be appropriately added to the display panel of the present invention. In other words, the configurations of (5) to (8) are modification examples of the display panel of the present invention.

### SUMMARY OF EMBODIMENT

As stated above, in a display panel according to one aspect of the present invention, a pitch at which the plurality of second row control lines are arranged is substantially equal to a pitch at which the plurality of second row unit circuits are arranged.

As in the first display screen, by making the pitch at which the plurality of second row unit circuits are arranged smaller than the pitch at which the plurality of second row control lines are arranged, it is possible to have an open region in the frame region. However, because there are not many rows in the second display screen (number of second row control lines), even if the pitch at which the plurality of second row unit circuits are arranged were to be made slightly smaller, it is not possible to have a sufficient open region to reduce the area taken up by the entire second row control circuit. Thus, in the second display screen, it is preferable that the pitch at which the plurality of row unit circuits are arranged be equal to the pitch at which the plurality of second row control lines are arranged.

Also, in a display panel according to one aspect of the present invention, an edge of the second display screen on a side of the first display screen, and an edge of the second row control circuit on a side of the first row control circuit are aligned in substantially one line with respect to each other.

According to the configuration above, the distance between the first row control circuit and the second row control circuit becomes substantially equal to the distance between the first display screen and the second display screen. As a result, it is possible to reliably pass control lines for controlling the second display screen through the boundary region between the first display screen and the second display screen.

Also, a display panel according to one aspect of the present invention further includes a first column control circuit including a plurality of first column unit circuits, respectively provided for the respective first column control lines and disposed along a direction perpendicular to the plurality of first column control lines, and being disposed on the side where the external terminals are disposed, a pitch at which the plurality of first column unit circuits are arranged being less than a pitch at which the plurality of first column control lines are arranged.

In order to prevent the outer dimensions of the display panel from becoming large, it is preferable that the pitch at which the plurality of first column unit circuits are arranged be slightly smaller than the pitch at which the plurality of first column control lines are arranged.

Also, in a display panel according to one aspect of the present invention, a minimum distance from an edge of the first display screen perpendicular to the side where the external terminals are disposed to an edge of the substrate parallel to the edge of the first display screen is substantially equal to a minimum distance from an edge of the second display screen perpendicular to the side where the external terminals are disposed to an edge of the substrate parallel to the edge of the second display screen.

According to this configuration, the display panel can be suitably installed in an electronic device.

The specific embodiments or examples provided in the detailed description of the present invention section are merely for illustration of the technical contents of the present invention. The present invention shall not be narrowly interpreted by being limited to such specific examples. Various changes can be made within the spirit of the present invention and the scope as defined by the appended claims.

### INDUSTRIAL APPLICABILITY

The present invention can be applied to a display panel using electroluminescence (EL), plasma, electrochromism, or the like as the display medium, for example, and the present invention can also be applied to various display devices such as liquid crystal display devices, EL display devices, and electrophoretic display devices including the display panel according to the present invention. Also, the display panel of the present invention can be used in electronic devices including the above-mentioned display device as the display part, and examples of such electronic devices include mobile telephones, PDAs (personal digital assistants), DVD (digital versatile disc) players, mobile gaming systems, laptop computers, PC (personal computer) monitors, and television receivers.

### DESCRIPTION OF REFERENCE CHARACTERS

1,100 display panel
2A, 102A opposite electrode
2B, 102B opposite electrode
3, 103 opposite substrate
4, 104 sealing member
5, 105 element substrate
6, 106 protective circuit
7, 107 circuit
8, 108 video signal line
9, 109 external terminals
10A, 110A first display screen
10B, 110B second display screen
11A, 111A first row control line
11B, 111B second row control line
12A, 112A first column control line
12B, 112B second column control line
13A, 113A first row control circuit
13a unit circuit of first row control circuit
13B, 113B second row control circuit
13b unit circuit of second row control circuit
14A, 114A first column control circuit
14a unit circuit of first column control circuit
14B, 114B second column control circuit
14b unit circuit of second column control circuit
15A, 115A first common transfer wiring line
15B, 115B second common transfer wiring line
116 driver IC
17A first storage capacitance line
20A to 20H, 120A to 120H common transfer part
30A subpixel region
30B pixel region

1. A display panel, comprising:
a substrate having a display region and a frame region that is a non-display region surrounding the display region;
external terminals disposed on only one side out of four sides constituting the frame region;
a first display screen provided in the display region, the first display screen including a plurality of first row control lines disposed so as to be parallel to a side where the external terminals are disposed, and a plurality of first column control lines intersecting with the plurality of first row control lines;
a second display screen provided in a position of the display region opposite to the external terminals across the first display screen, the second display screen including a plurality of second row control lines that are fewer in number than the plurality of first row control lines and that are disposed so as to be parallel to the plurality of first row control lines, and a plurality of second column control lines that intersect with the plurality of second row control lines;
a first row control circuit disposed on a side perpendicular to the side where the external terminals are disposed, the first row control circuit including a plurality of first row unit circuits, respectively provided for the respective first row control lines and arranged along a direction perpendicular to the plurality of first row control lines;
a second row control circuit disposed on the side where the first row control circuit is disposed, the second row control circuit including a plurality of second row unit circuits, respectively provided for the respective second row control lines and arranged along a direction perpendicular to the plurality of second row control lines; and
control lines for controlling the second display screen that extend through the frame region from the external terminals to the second display screen so as to avoid the first row control circuit,
wherein a pitch at which the plurality of first row unit circuits are arranged is less than a pitch at which the plurality of first row control lines are arranged, and
wherein an edge of the first display screen adjacent to the second display screen, and an edge of the first row control circuit adjacent to the second row control circuit are aligned in substantially one line with respect to each other.

2. The display panel according to claim 1, wherein a pitch at which the plurality of second row control lines are arranged is substantially equal to a pitch at which the plurality of second row unit circuits are arranged.

3. The display panel according to claim 1, wherein an edge of the second display screen adjacent to the first display screen, and an edge of the second row control circuit adjacent to the first row control circuit are aligned in substantially one line with respect to each other.

4. The display panel according to claim 1, further comprising a first column control circuit including a plurality of first column unit circuits, respectively provided for the respective first column control lines and disposed along a direction perpendicular to the plurality of first column control lines, and being disposed on the side where the external terminals are disposed,
wherein a pitch at which the plurality of first column unit circuits are arranged is less than a pitch at which the plurality of first column control lines are arranged.

5. The display panel according to claim 1, wherein a minimum distance from an edge of the first display screen perpendicular to the side where the external terminals are disposed to an edge of the substrate parallel to said edge of the first display screen is substantially equal to a minimum distance from an edge of the second display screen perpendicular to the side where the external terminals are disposed to an edge of the substrate parallel to said edge of the second display screen.

6. A display device, comprising the display panel according to claim 1.

7. An electronic device, comprising the display panel according to claim 1.
